(19) United States
(12) Patent Application Publication
(10) Pub. No.: US 2009/0323474 A1
(43) Pub. Date: Dec. 31, 2009

(54) SOUND SOURCE DETECTING DEVICE AND METHOD THEREOF

(75) Inventor: SHI-QUAN LIN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HON HAI PRECISION INDUSTRY (ShenZhen) CO., LTD., Shenzhen City (CN); HON HAI PRECISION INDUSTRY CO., LTD., Tu-Cheng (TW)

(21) Appl. No.: 12/488,528

(22) Filed: Jun. 20, 2009

(30) Foreign Application Priority Data
Jun. 26, 2008 (CN) 200810302345.7

(51) Int. Cl. G01S 3/80

(52) U.S. Cl. 367/118

(57) ABSTRACT

A sound source detecting device includes a number of sound wave detectors, a voltage comparator, and an analyzer. The sound wave detectors are positioned at different positions, and configured for detecting a sound wave, and each of the detectors produces an electrical signal associated to the sound wave detected by the detector and outputting the electrical signal. The voltage comparator is connected to the detectors and configured for receiving the electrical signals transmitted from the detectors and comparing the voltages of electrical signals to get the highest, second highest, and lowest voltages, then outputs a comparison result. The analyzer is connected to the voltage comparator and configured for identifying the position of a sound source producing the sound wave according to the comparison result transmitted from the voltage comparator and a predetermined principle stored in the analyzer, and then outputs an analyzing result indicating the direction of the sound source.

### BACKGROUND

1. Technical Field

The disclosure relates to an object locating device and, more particularly, to a sound source detecting device and a method thereof.

2. Description of Related Art

Sound source detecting devices, such as sonars, are almost solely used underwater in the past to detect a location of an object producing a detectable sound. Today, sound source detecting devices are used in quite a few circumstances, for example, in vehicles, in robots, or in aircrafts to detect a location of an object producing sound. Since the arrival time is proportional to the length of the sound propagable path extending between the sound source and the sound source detecting devices. In the traditional method for detecting the location of a sound source, a number of sound wave detectors are distributed at different positions of a carrier. A calculagraph is configured to record the arrival time of each sound wave detected by different detectors. A calculator is configured to count a time difference between every two sequent arrival times, and the time differences between the arrival times constitute the indexes for determining the location of the sound source. However, when the detectors are positioned very close, the differences in distance for the sound propagable path become correspondingly difficult to determine, thereby making it impossible to accurately determine the direction of the sound source by calculating the time difference of every two sequent arrival times.

Therefore, what is needed is to provide a sound source detecting device, in which the above problem is eliminated or at least alleviated.

### BRIEF DESCRIPTION OF THE DRAWINGS

FIG. 1 is a block diagram showing a sound source detecting device, according to an exemplary embodiment.

FIG. 2 is a diagrammatic sketch showing an exemplary arrangement form of three sound wave detectors and a number of indicators of the sound source detecting device shown in FIG. 1.

FIG. 3 is a flowchart showing the sound source detecting method of the sound source detecting device shown in FIG. 1, according to an embodiment.

### DETAILED DESCRIPTION

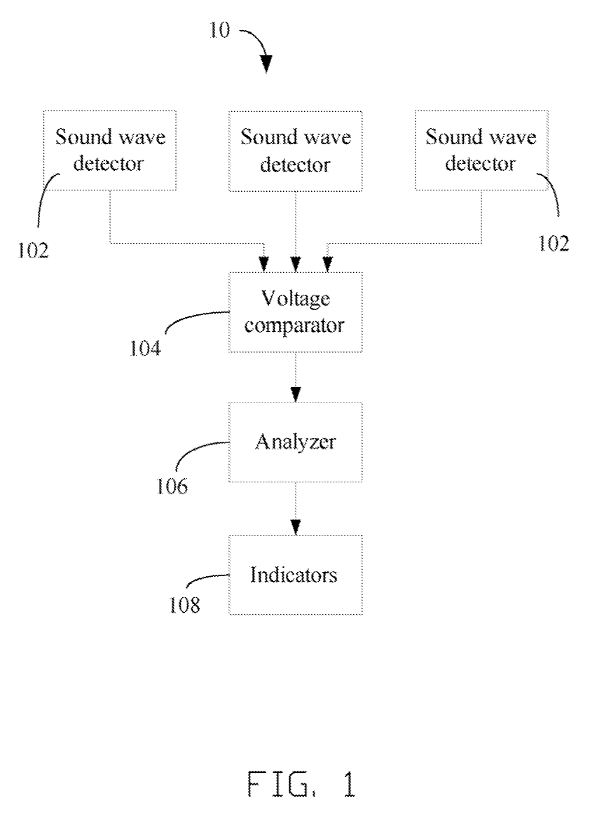

Referring to FIG. 1, a sound source detecting device 10 according to a preferable embodiment of the present invention is provided. The sound source detecting device 10 includes three sound wave detectors 102 (hereinafter referred to as detectors), a voltage comparator 104 connected to the detectors 102, an analyzer 106 connected to the voltage comparator 104, and a number of indicators 108 connected to the analyzer 106.

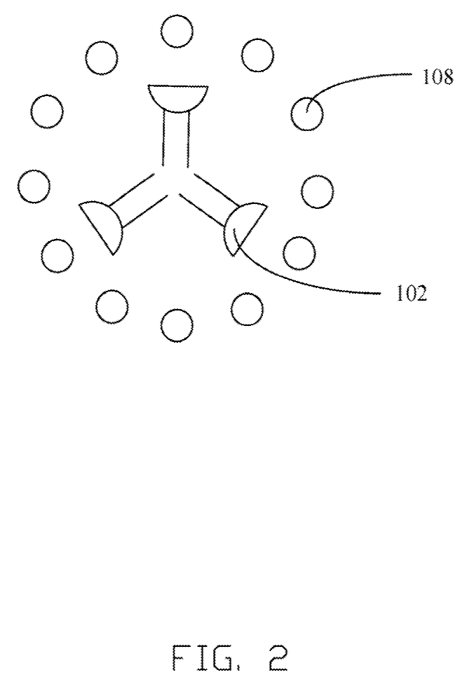

Referring to FIG. 2, as an exemplary embodiment, the three detectors 102 are arranged to be evenly positioned on a circular track and separated at an equivalent angel of about 120 degrees. Alternatively, the number of the detectors 102 is not limited in three as described above, however, they can be more. The detectors 102 can be arranged to be regularly positioned as a form of triangle, circle, quadrangle, or regular polygon and so on. Each of the detectors 102 includes a sensitive surface exposed toward to a different direction. The detectors 102 are configured to detect a sound wave produced by a sound source, and then transform the sound wave into a corresponding electrical signal and then feed the electrical signals to the voltage comparator 104.

Referring to FIGS. 1 and 2, the voltage comparator 104 is configured to compare the voltages of the three electrical signals to get the highest voltage, the lowest voltage, and the second highest voltage, and then transmits a comparison result to the analyzer 106.

The analyzer 106 is configured to identify the sound source direction according to the comparison result. Since the three detectors 102 are arranged on a circular track and separated at an equivalent angel about 120 degree, the sound wave produced by the sound source will be attenuated during transmitting in a transmission medium. The peaks of the intensity of the sound wave at different positions detected by the individual detectors 102 are therefore different from each other, and the peak differences of the sound wave are represented in the voltages of the electrical signals transmitted by the detectors 102. Therefore, the voltages relationships of the three electrical signals represent the relationships of the peaks of intensity of the sound wave at different positions. The peaks of the intensity of the sound wave represent the positions or locations of the detectors 102 in the propagation path of the sound wave with respect to the sound source generated the sound wave. Thereby, the analyzer 106 can determine the direction of the sound source relative to the detectors 102 by analyzing the comparison result transmitted from the voltage comparator 104. Preferably, the analyzer 106 can identify the direction of the sound source according to a predetermined principle previously stored in the analyzer 106. The predetermined principle is that, for example, the direction of the sound source is towards one of the detectors 102 associated with the electrical signal with the highest voltage outputted by the detectors 102, and inclined more to the detector 102 associated with the second highest voltage than to the detector 102 with the lowest voltage. That means the direction of the sound source is facing toward the detector 102 that produces the electrical signal with the highest voltage. The predetermined principle also can be that if two voltages of the electrical signals are equal to each other and the third voltage is lower or higher than the two equal voltages, the direction of the sound source is locating on the extending line of the middle line of the line connecting two detectors 102 associated with the two equal voltages, and towards to or aparts from the third detector 102. Then the analyzer 106 will output an analyzing result indicated the direction of the sound source to the indicators 108.

The indicators 108 are configured to receive the analyzing result outputted from the analyzer 106 and emit a readable signal to indicate the sound source direction. The indicators 108 are lights/lamps and evenly positioned around the detectors 102. Alternatively, the indicators 108 can be substituted by other displaying media or indicating media.

In summary, the differences between the voltages of the electrical signals produced by the detectors are more definite than the differences between the arrival times when a sound wave arrived to the detectors. Therefore, even if the detectors are positioned adjacently, the location of a sound source can be precisely detected.

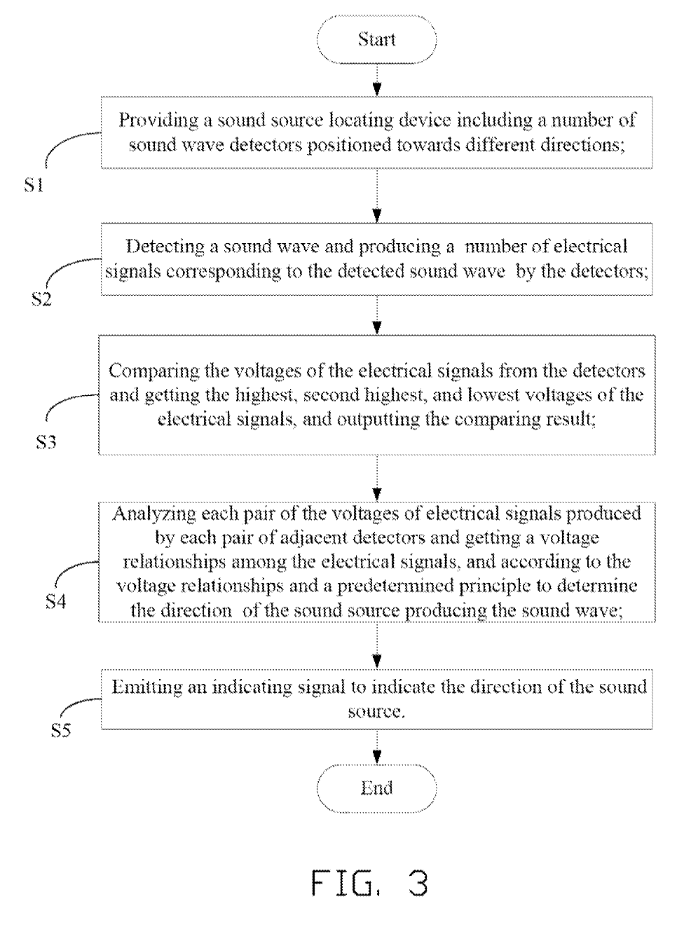

Referring to FIG. 3, a sound source detecting method according to an embodiment includes following steps as S1 to S5;

In step S1, a sound source detecting device including a number of sound wave detectors is provided and the wave detectors are positioned towards different directions.

In step S2, a sound wave generated by the sound source is detected by the detectors, and a corresponding number of electrical signals associating to the detected sound waves are produced by the detectors.

In step S3, the voltages of the electrical signals outputted from the detectors are compared to get the highest, second highest, and lowest voltages of the electrical signals, and a comparing result is outputted.

In step S4, each pair of the voltages of electrical signals produced by each pair of adjacent detectors is analyzed to get a voltage relationship among the electrical signals. The direction of the sound source producing the sound wave is determined according to the voltage relationships and a predetermined principle. The predetermined principle adopted to definite the direction of the sound source is that if all voltages of electrical signals produced by the detectors are different from each other, the direction of the sound source is towards one of the detectors associating to the highest voltage and inclined to another one of the detectors associated to the second highest voltage; and if two voltages in all voltages of the electrical signal are equal to each other and the third voltage is lower or higher than the two equal voltages, the direction of the sound source is locating on the extending line of the middle line of the line connecting the two detectors associated with the two equal voltages, and towards to or aparts from the third detector associated to a higher or lower voltage accordingly;

In step S5, an indicating signal is emitted to indicate the direction of the sound source.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A sound source detecting device comprising:
at least three sound wave detectors positioned at different positions and directions and configured to detect a sound wave, each of the detectors being configured for producing an electrical signal associated to the sound wave detected by the detectors and outputting the electrical signal;
a voltage comparator connected to the detectors and configured to compare the voltages of the electrical signals transmitted from the detectors to get the highest voltage, second highest voltage and the lowest voltage, and output a comparison result; and
an analyzer connected to the voltage comparator and configured to identify the sound source direction according to the comparison result transmitted from the voltage comparator and a predetermined principle stored in the analyzer, and outputting an analyzing result.

2. The sound source detecting device as claimed in claim 1, further comprising a plurality of indicators connected to the analyzer and configured to receive the analyzing result transmitted from the analyzer and emit a readable signal indicating the direction of the sound source.

3. The sound source detecting device as claimed in claim 2, wherein the detectors are arranged as a form of triangle, circle, quadrangle, or regular polygon; and the indicators are positioned around the detectors.

4. The sound source detecting device as claimed in claim 2, wherein the at least three sound wave detectors comprise three sound wave detectors; and the predetermined principle is that the direction of the sound source is towards one of the detectors associated with the electrical signal of the highest voltage, and inclined to the detector associated with the electrical signal with a second highest voltage.

5. The sound source detecting device as claimed in claim 2, wherein the at least three sound wave detectors comprise three sound wave detectors, and the predetermined principle is that if two voltages in all three voltages of the electrical signals are equal to each other and the third voltage is lower or higher than the two equal voltages, the direction of the sound source is locating on the extending line of the middle line of the line connecting the two detectors associated with the two equal voltages, and towards to or aparts from the rest one detector associated with the higher or lower voltages accordingly.

6. The sound source detecting device as claimed in claim 2, wherein the indicators are lamps.

7. The sound source detecting device as claimed in claim 2, wherein the indicators are displaying media.

8. A sound source locating method comprising following steps:
providing a sound source detecting device including a number of evenly arranged sound wave detectors positioned towards different directions;
detecting a sound wave by the detectors and producing a corresponding number of electrical signals associating to the sound wave detected by the detectors;
comparing the voltages of the electrical signals from the detectors and outputting a comparing result; and
getting a direction of a sound source producing the sound wave according to the comparing result and a predetermined principle.

9. The sound source locating method as claimed in claim 8, further comprising a step of emitting an indicating signal to indicate the direction of the sound source.

10. The sound source locating method as claimed in claim 8, further comprising following steps:
getting the highest, second highest, and lowest voltages of the electrical signals; and
analyzing each pair of the voltages of electrical signals produced by each pair of adjacent detectors and getting a voltage relationship among the electrical signals, defining the direction of the sound source according with the voltage relationships.

11. The sound source locating method as claimed in claim 10, wherein the predetermined principle is that if all voltages of electrical signals produced by the detectors are different from each other, the direction of the sound source is towards one of the detectors associating to the highest voltage and inclined to another one of the detectors associating to the second highest voltage.

12. The sound source locating method as claimed in claim 11, wherein the predetermined principle further comprises that if the number of sound wave detectors is three and two voltages in all three voltages of the electrical signal are equal to each other and the third voltage is lower or higher than the two equal voltages, the direction of the sound source is locating on the extending line of the middle line of the detectors associating with the two equal voltages, and towards to or aparts from the rest one detector accordingly.
